(19) United States
(12) Patent Application Publication
(10) Pub. No.: US 2020/0101649 A1
(43) Pub. Date: Apr. 2, 2020

(54) DEVICE FOR ASSISTING MOLDING CONDITION DETERMINATION AND INJECTION MOLDING APPARATUS

(71) Applicant: JTEKT Corporation, Osaki-shi (JP)

(72) Inventors: Yusuke OKUBO, Kariya-shi (JP); Masaharu Hasuike, Kariya-shi (JP); Toshiyuki Baba, Kashihara-shi (JP); Kouji Kimura, Shiki-gun (JP)

(73) Assignee: JTEKT Corporation, Osaka-shi (JP)

(21) Appl. No.: 16/580,006

(22) Filed: Sep. 24, 2019

(30) Foreign Application Priority Data
Sep. 27, 2018 (JP) 2018-182661

(51) Int. Cl. B29C 45/76; G05B 13/02; G05B 19/042

(52) U.S. Cl. CPC B29C 45/766; B29C 45/762; G05B 13/0265; B29C 2945/761; B29C 2945/7613; G05B 2219/45244; G05B 19/042

(57) ABSTRACT

A device for assisting molding condition determination is used with a molding method that molds an article by feeding molten material into a mold. The device includes a learning model generating unit, an input unit, and an output unit. The learning model generating unit creates a learning model through machine learning in which a plurality of molding condition element items used to mold the article and a plurality of quality element items of the molded article are used as learning data. The learning model relates to a degree of influence of each molding condition element item on each quality element item. The input unit receives input of a subject quality element item to be checked, selected from the quality element items. The output unit outputs, using the learning model, the multiple molding condition element item that has the degree of influence on the subject quality element item.

### INCORPORATION BY REFERENCE

The disclosure of Japanese Patent Application No. 2018-182661 filed on Sep. 27, 2018 including the specification, drawings and abstract, is incorporated herein by reference in its entirety.

### BACKGROUND OF THE INVENTION

### 1. Field of the Invention

The invention relates to a device for assisting molding condition determination and an injection molding apparatus.

### 2. Description of Related Art

In a method of molding articles by feeding molten material into a mold, such as injection molding, if defects occur in the molded article, an operator needs to change the molding conditions. Since the molding method uses molten material and a mold, the quality of molded articles is influenced by various factors such as: the environment of the area where a factory equipped with molding equipment is located; the environment inside the factory; the installation condition of the equipment in the factory; age deterioration of the equipment; and season. Therefore, some experience and skills are required to change the molding conditions by taking into account such various factors. It is difficult for an unskilled operator to determine how much and which molding condition needs to be changed.

These days, with improvements in computer processing speed, artificial intelligence is developing rapidly. For example, Japanese Unexamined Patent Application Publication No. 2017-30152 (JP 2017-30152 A) discloses that machine learning is used to reduce the time taken to adjust operating conditions for injection molding. Specifically, a reward is calculated based on both physical amount data relating to a molded article (corresponding to the quality of a molded article) and reward conditions for machine learning, and an adjustment of the operating conditions is performed by machine learning based on the reward, the operating conditions, and the physical amount data.

Examples of the physical amount data include: the weight and size of a molded article; an appearance, a length, an angle, an area, and a volume calculated from image data on a molded article; the result of an optical inspection of an optically molded article; and the strength measurement result of a molded article. That is, the physical amount data corresponds to the quality of a molded article. Examples of the operating conditions (corresponding to molding conditions) include: a mold clamping condition, an ejector condition, an injection dwell condition, a measuring condition, a temperature condition, a nozzle touch condition, a resin feed condition, a mold thickness condition, a molded article removal condition, and a hot runner condition. The technique disclosed in JP 2017-30152 A is intended to automatically adjust molding conditions when defects occur in a molded article. This eliminates the need of adjustment by the operator.

However, such fully automatic adjustment of molding conditions may be inappropriate when considering education of the operator, succession of techniques, etc. Further, although computers are developing, the need for the operator to operate equipment will not completely go away in the future.

### SUMMARY OF THE INVENTION

A purpose of the invention is to provide a device for assisting an operator in determining a molding condition, for example, when defects occur in a molded article, and to provide an injection molding apparatus including the device.

An aspect of the invention provides a device for assisting molding condition determination and for use with a molding method that molds an article by feeding molten material into a mold. The device includes a learning model generating unit, an input unit, and an output unit. The learning model generating unit creates a learning model through machine learning in which a plurality of molding condition element items used to mold the article and a plurality of quality element items of the molded article are used as learning data. The learning model relates to a degree of influence of each of the molding condition element items on each of the quality element items. The input unit receives input of a subject quality element item to be checked. The subject quality element item is selected from the quality element items. The output unit outputs, using the learning model, the molding condition element item that has the degree of influence on the subject quality element item.

When defects occurs in the molded article, an operator checks which of the quality element items is defective. Then, the operator inputs the defective quality element item to the input unit, so that the input unit receives input of the subject quality element item to be checked. In response to the input, the output unit outputs the molding condition element item that has the degree of influence on the subject quality element item. The relationship between the quality element item received by the input unit and molding condition element item that has the degree of influence on the quality element item is easily obtainable through machine learning. Thus, by using the learning model created through machine learning, the output unit easily outputs the molding condition element item that has the degree of influence on the subject quality element item.

This allows the operator to be informed which molding condition element items need to be adjusted in order to correct the defective quality element item. By repeating the adjustment, the operator learns the relationship between the quality element and the molding condition element and thus becomes skillful in adjusting the molding condition element.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a diagram illustrating an injection molding apparatus;

FIG. 2 is a block diagram of a molding condition determination assisting device according to a first embodiment;

FIG. 3 is a diagram illustrating learning data used in a learning model generating unit;

FIG. 4 is a diagram illustrating a learning model generated by the learning model generating unit;

FIG. 5 is a diagram illustrating a first display example of a display unit;

FIG. 6 is a diagram illustrating a second display example of the display unit;

FIG. 7 is a diagram illustrating a third display example of the display unit;

FIG. 8 is a block diagram of a molding condition determination assisting device according to a second embodiment;

FIG. 9 is a diagram illustrating a fourth display example of a display unit; and

FIG. 10 is a diagram illustrating a fifth display example of the display unit.

### DETAILED DESCRIPTION OF EMBODIMENTS

A molding condition determination assisting device 50 (hereinafter referred to simply as the assisting device 50) according a first embodiment is used with a molding method that molds an article by feeding molten material into a mold of a molding apparatus. For example, the molding method may be injection molding of resin, rubber, or the like, or may be metal casting such as die casting. In the description below, injection molding is mainly taken as an example of the molding method to describe the assisting device 50.

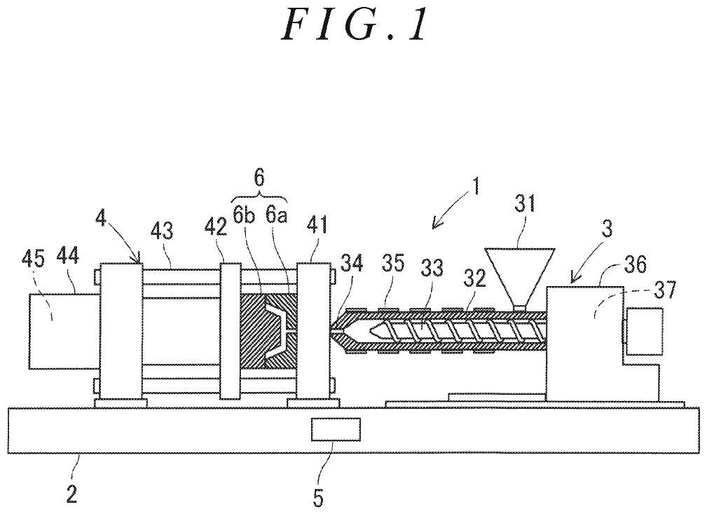

An injection molding apparatus 1 that performs injection molding is described with reference to FIG. 1. The assisting device 50 may be either included in the injection molding apparatus 1 or separated from the injection molding apparatus 1. The injection molding apparatus 1 includes a bed 2, an injection device 3, a clamping device 4, and a control device 5. The injection device 3 is mounted on the bed 2. The injection device 3 heats and melts molding material and then injects the molding material under high pressure into a cavity of a mold 6. The molding material that has been heated and molten is hereinafter referred to as molten material.

The injection device 3 includes a hopper 31, a heating cylinder 32, a screw 33, a nozzle 34, a heater 35, a drive device 36, and an injection device sensor 37. Pellets (molding material in the form of particles) are fed into the hopper 31. The heating cylinder 32 heats and melts the pellets in the hopper 31 into molten material and pressurizes the molten material. The heating cylinder 32 is axially movable relative to the bed 2. The screw 33 is mounted inside the heating cylinder 32 in a manner such that the screw 33 is rotatable and axially movable in the heating cylinder 32.

The nozzle 34 is an injection opening provided at the tip of the heating cylinder 32 and feeds the molten material in the heating cylinder 32 into the cavity of the mold 6 in accordance with the axial movement of the screw 33. The heater 35 is mounted, for example, to the outside of the heating cylinder 32 and heats the pellets in the heating cylinder 32. The drive device 36 performs the axial movement of the heating cylinder 32 and also performs the rotation and axial movement of the screw 33. The injection device sensor 37 is a general term for sensors that obtain various types of information relating to the injection device 3, including: the amount of stored molten material; a dwell pressure; a dwell time; an injection speed; and the condition of the drive device 36. The injection device sensor 37 may obtain information other than that described above.

The clamping device 4 is mounted on the bed 2 and faces the injection device 3. The clamping device 4 opens and closes the mold 6 attached thereto, and also clamps the mold 6 such that the mold 6 is not opened by pressure of the molten material injected into the cavity of the mold 6.

The clamping device 4 includes a fixed platen 41, a movable platen 42, a tie bar 43, a drive device 44, and a clamping device sensor 45. A first mold 6a as a fixed part of the mold 6 is fixed to the fixed platen 41. The fixed platen 41 is abutable with the nozzle 34 of the injection device 3 and guides the molten material injected from the nozzle 34 into the cavity of the mold 6. The second mold 6b as a movable part of the mold 6 is fixed to the movable platen 42. The movable platen 42 is movable toward and away from the fixed platen 41. The tie bar 43 supports the movement of the movable platen 42. The drive device 44 moves the movable platen 42. For example, the drive device 44 may be structured as a cylinder device. The clamping device sensor 45 is a general term for sensors that obtain various types of information, including: a mold clamping force; a mold temperature; and the condition of the drive device 44.

The control device 5 controls both the drive device 36 of the injection device 3 and the drive device 44 of the clamping device 4 on the basis of a command value for a molding condition. Specifically, the control device 5 obtains various types of information from the injection device sensor 37 and the clamping device sensor 45, and controls the drive device 36 of the injection device 3 and the drive device 44 of the clamping device 4 so as to cause the injection device 3 and the clamping device 4 to operate in accordance with the command value.

Below is a description of a method of injection molding performed by the injection molding apparatus 1. The injection molding method includes the following successive steps: a measuring step; a clamping step; an injection filling step; a dwell cooling step; and a removing step. In the measuring step, pellets are melted into molten material by heat from the heater 35 and by shear frictional heat generated by rotation of the screw 33, and the molten material is stored between the tip of the heating cylinder 32 and the nozzle 34. As the amount of the stored molten material increases, the screw 33 retracts. Thus, the amount of the stored molten material is measured from a retracted position of the screw 33.

Then, in the clamping step, by moving the movable platen 42, the first mold 6a and the second mold 6b are brought together to clamp the mold 6. Further, the nozzle 34 is connected to the fixed platen 41 of the clamping device 4. Next, in the injection filling step, by moving the screw 33 toward the nozzle 34 while stopping the rotation of the screw 33, the molten material is injected at high pressure into the cavity of the mold 6 and fills the cavity. In the dwell cooling step after the injection filling step, the nozzle 34 is held pressed against the fixed platen 41 to maintain the molten material in the cavity of the mold 6 at a predetermined pressure. Then, the mold 6 is cooled so that the molten material in the cavity of the mold 6 is solidified into a molded article. Finally, in the removing step, the molded article is removed by separating the first mold 6a and the second mold 6b from each other.

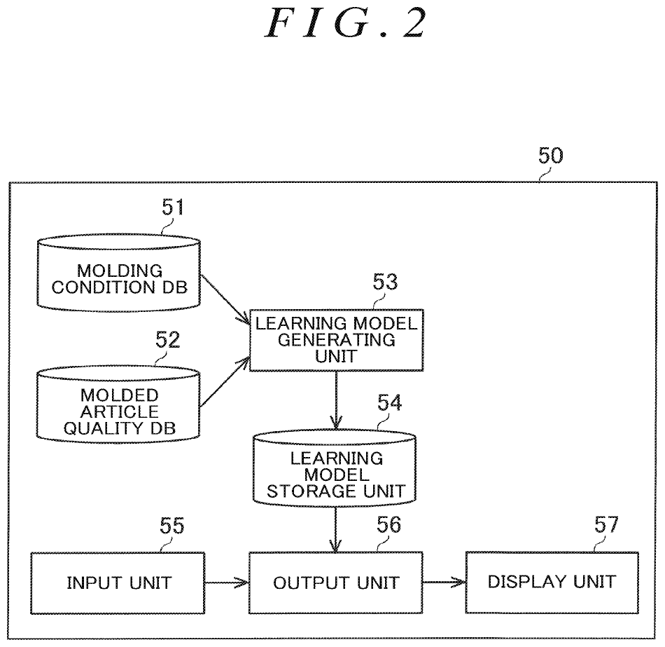

Referring to FIGS. 2 to 4, the structure of the assisting device 50 according to the first embodiment is described. The assisting device 150 includes a molding condition database (DB) 51, a molded article quality database (DB) 52, a learning model generating unit 53, a learning model storage unit 54, an input unit 55, an output unit 56, and a display unit 57.

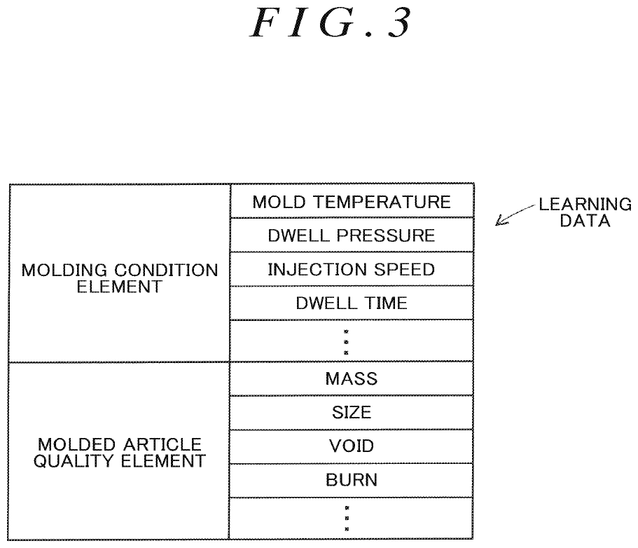

Molding condition elements for multiple articles to be molded that are input as command values to the control device 5 are stored in the molding condition database 51 in association with the respective articles. For example, as illustrated in FIG. 3, the molding condition element includes the following items: a mold temperature; a dwell pressure; an injection speed; a dwell time; a mold clamping force; and the amount of molten material stored in the heating cylinder 32. The molding condition database 51 stores such molding condition elements relating to multiple articles to be molded. That is, the molding condition database 51 stores molding condition elements regarding the shapes and materials of multiple articles to be molded.

The molded article quality database 52 stores quality elements of multiple molded articles in association with the respective molded articles. As illustrated in FIG. 3, the quality element may include the following items: the mass of a molded article; the size of the molded article; the condition of voids in the molded article; and the condition of burns on the molded article. The quality element is information obtained after molding of the article through inspection by an inspection apparatus (not illustrated) or any other suitable method. The quality element may be an inspection value of each item directly obtained by the inspection or may be an evaluation value derived from the inspection value.

According to the first embodiment, the molding condition database 51 and the molded article quality database 52 are separate databases. Alternatively, these databases 51 and 52 may be an integrated database. In the case, the molding condition element and the quality element are stored in association with each molded article.

The learning model generating unit 53 functions in a learning phase of machine learning and creates a learning model. The learning model is a graphical model, i.e., a probabilistic model for which a graph expresses the conditional dependence structure between random variables. According to the first embodiment, the learning model generating unit 53 uses supervised learning to create the leaning model. Alternatively, the learning model generating unit 53 may use any other suitable machine learning algorithm. Examples of the machine learning include the following: a deep learning algorithm; a graphical lasso algorithm; a graphical Gaussian model; and a Bayesian network. The learning model created by the learning model generating unit 53 is stored in the learning model storage unit 54.

As illustrated in FIG. 3, the learning model generating unit 53 obtains, as the learning data, the molding condition element stored in the molding condition database 51 and the quality element stored in the molded article quality database 52, in association with each molded article. Thus, for each molded article, the learning model generating unit 53 performs machine learning using the associated molding condition element and quality element.

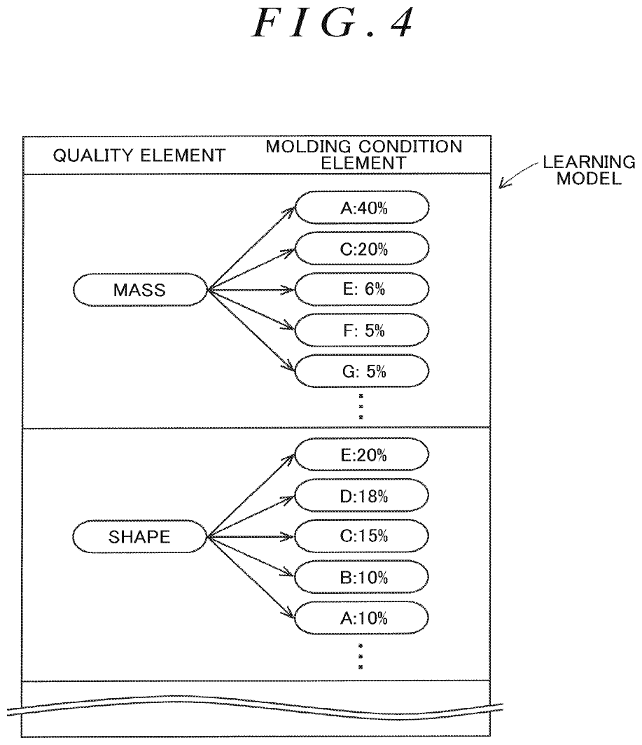

Through the machine learning, the learning model generating unit 53 generates the learning model relating to a degree of influence of the quality element and the molding condition element for each quality element item. The learning model is a graphical model, for example, like the one illustrated in FIG. 4. That is, the learning model indicates which molding condition element item each quality element item depends on (i.e., has the degree of influence on). Further, the learning model indicates how much each quality element item influences (i.e., depends on) the molding condition element item.

For example, in the example of FIG. 4, out of the molding condition element items, “A” has a degree of influence of 40%, “B” has a degree of influence of 20%, “E” has a degree of influence of 6%, “F” has a degree of influence of 5%, and “G” has a degree of influence of 5%, on the mass of a molded product as one of the quality element items. For the shape of a molded product as one of the quality element items, “E” has a degree of influence of 20%, “D” has a degree of influence of 18%, “C” has a degree of influence of 15%, “B” has a degree of influence of 10%, and “A” has a degree of influence of 10%. In FIG. 4, different letters such as “A” denote different molding condition element items in a conceptualized and simplified manner. For example, “A” may denote a dwell pressure.

The input unit 55, the output unit 56, and the display unit 57 function in an estimation phase (sometimes called an inference phase) of the machine learning. Their functions in the estimation phase are described below. An operator who operates the injection molding apparatus 1 obtains the quality element of a molded article. If any quality element item of the obtained quality element of the molded article has deviation from its target value, the operator needs to adjust the molding condition element so as to approximate the molding condition element to the target value. In this case, the operator uses the assisting device 50 to input the quality element item that has deviation from the target value. In response to the input, the assisting device 50 automatically outputs molding condition element items that have the degree of influence on the input quality element item. Thus, by inputting a quality element item that has deviation from its target value, the operator obtains molding condition element items that have the degree of influence on the input quality element item. This allows the operator to determine that the obtained molding condition element items need to be adjusted. A quality element item input by the operator to the assisting device 50 is hereinafter referred to as a subject quality element item to be checked.

The input unit 55 receives input of the subject quality element item from the operator. As described above, the subject quality element item is a quality element item that has deviation from its target value. Further, the input unit 55 receives, from the operator, input information indicating whether to output the degrees of influence of molding condition element items corresponding to the subject quality element item. Further, the input unit 55 receives input of an output condition that defines how the output unit 56 outputs the molding condition element items. Examples of the output condition includes the following: whether to output the molding condition element items in descending or ascending order of the degree of influence (the order in which the molding condition element items are to be displayed); whether to output all or a predetermined number of the molding condition element items (the number of the molding condition element items to be displayed); and whether to output the degrees of influence.

The output unit 56 uses the learning model stored in the learning model storage unit 54 to output molding condition element items that have the degree of influence on the subject quality element item input to the input unit 55. The output unit 56 may output only molding condition element items that have a high degree of influence. For example, the output unit 56 may output only molding condition element items that have a degree of influence higher than a predetermined value or may output a predetermined number of molding condition element items in descending order of the degree of influence. Alternatively, the output unit 56 may output all the molding condition element items that have the degree of influence on the subject quality element item. Further, for each of the molding condition element items that have the degree of influence on the subject quality element item, the output unit 56 outputs the degree of influence. The display unit 57 displays the input information and the output condition input to the input unit 55 and also displays the output information output from the output unit 56. Details of the display unit 57 are described later.

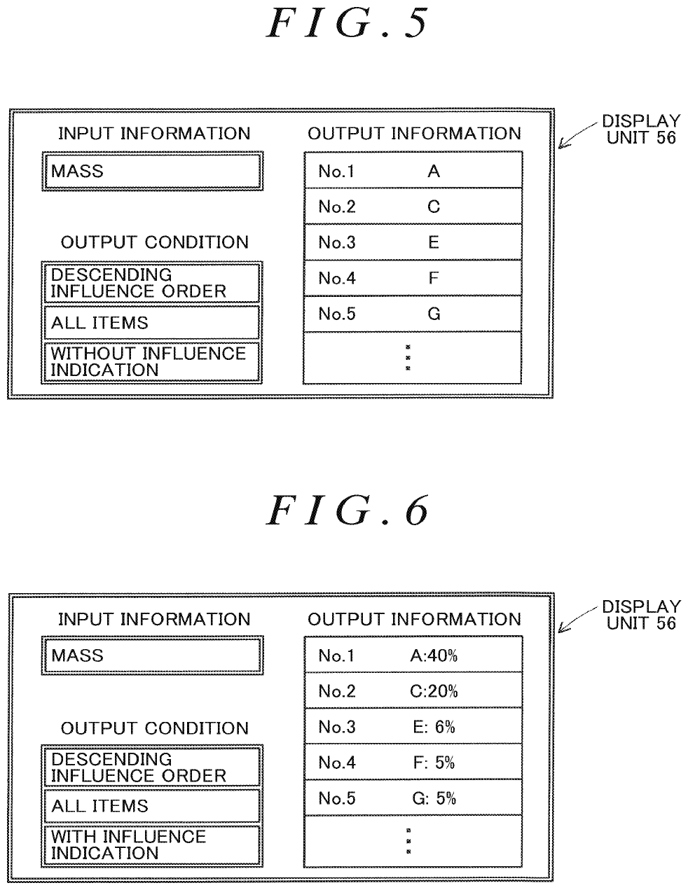

Referring to FIG. 5, a first display example of the display unit 57 is described. The first display example illustrates when the subject quality element item input as input information to the input unit 55 is the mass (item name), and when the output condition input to the input unit 55 is as follows: descending order of the degree of influence; all items; and without indication of the degree of influence. The input information and the output condition are displayed on the display unit 57 (on the left side of FIG. 5).

Further, output information output from the output unit 56 is also displayed on the display unit 57 (on the right side of FIG. 5). As illustrated in FIG. 5, the display unit 57 displays all the molding condition element items that have the degree of influence on the mass of the molded article in descending order of the degree of influence. Specifically, the molding condition element item “A” having the highest degree of influence on the mass is displayed in the top row of the display unit 57, and the other molding condition element items “C”, “E”, “F”, and “G” are displayed in this order from top down.

When the mass of a molded article has deviation from its target value, the operator inputs the item name “mass” to the input unit 55 as described above. In response to the input, the display unit 57 displays information as illustrated in FIG. 5, thus informing the operator which molding condition element items influence the mass. For example, the operator may adjust the displayed molding condition element items in descending order of the degree of influence until the quality element of a molded article meets its target value.

In this way, when defects occurs in a molded article, the operator first checks which of the quality element items is defective. Then, the operator inputs the defective quality element item to the input unit 55, so that the input unit 55 receives input of a subject quality element item to be checked. In response to the input, the output unit 56 outputs molding condition element items that have the degree of influence on the subject quality element item. The relationship between a quality element item received by the input unit 55 and molding condition element items that have the degree of influence on the quality element item is easily obtainable through machine learning. Thus, by using the learning model created through machine learning, the output unit 56 easily outputs the molding condition element items that have the degree of influence on the subject quality element item.

This allows the operator to be informed which molding condition element item needs to be adjusted in order to correct the defective quality element item. By repeating the adjustment, the operator learns the relationship between the quality element and the molding condition element and thus becomes skillful in adjusting the molding condition element.

Next, a second display example of the display unit 57 is described with reference to FIG. 6. The second display example illustrates when the subject quality element item input as input information to the input unit 55 is the mass (item name), and when the output condition input to the input unit 55 is as follows: descending order of the degree of influence; all items; and with indication of the degree of influence. The input information and the output condition are displayed on the display unit 57 (on the left side of FIG. 6).

Further, output information output from the output unit 56 is also displayed on the display unit 57 (on the right side of FIG. 6). As illustrated in FIG. 6, the display unit 57 displays all the molding condition element items that have the degree of influence on the mass of the molded article in descending order of the degree of influence. Specifically, the molding condition element item “A” having the highest degree of influence on the mass is displayed in the top row of the display unit 57, along with its degree of influence of 40%. Further, the other molding condition element items “C”, “E”, “F”, and “G” are displayed on the display unit 57 in this order from top down, along with their degrees of influence of 20%, 6%, 5%, and 5%, respectively.

When the mass of a molded article has deviation from its target value, the operator inputs the item name “mass” to the input unit 55 as described above. In response to the input, the display unit 57 displays information in a manner illustrated in FIG. 6, thus informing the operator which molding condition element items have the degree of influence on the mass. Further, the operator is informed how much the molding condition element items influence the mass. This allows the operator, for example, to determine, on the basis of the degree of influence, which molding condition element items to adjust with the amount of deviation from the target value taken into account. For example, the operator may choose to adjust the molding condition element item having an degree of influence of 20%, instead of the molding condition element item having the highest degree of influence.

In this way, it is possible for the operator to consider how and which molding condition element items to adjust on the basis of their degrees of influence. For example, the operator may consider which molding condition element items to adjust when the quality element item deviates slightly from the target value or when the quality element item deviates greatly from the target value.

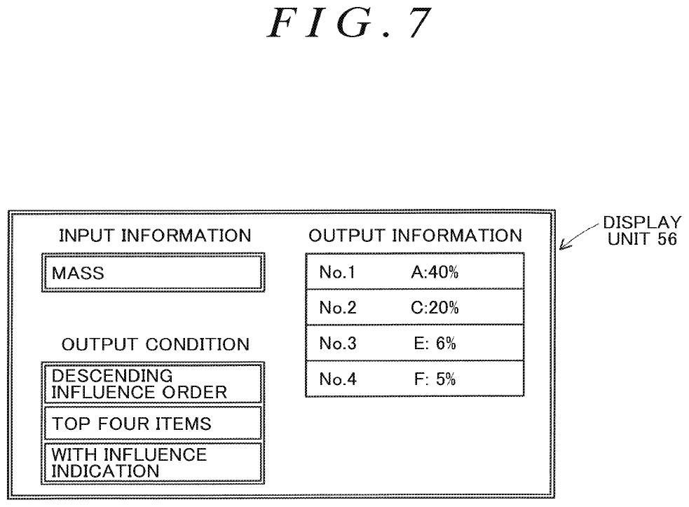

Next, a third display example of the display unit 57 is described with reference to FIG. 7. The third display example illustrates when the subject quality element item input as input information to the input unit 55 is the mass (item name), and when the output condition input to the input unit 55 is as follows: descending order of the degree of influence; top four items as a predetermined number of items; and with indication of the degree of influence. The input information and the output condition are displayed on the display unit 57 (on the left side of FIG. 7).

Further, output information output from the output unit 56 is also displayed on the display unit 57 (on the right side of FIG. 7). As illustrated in FIG. 7, the display unit 57 displays only the top four molding condition element items that have the degree of influence on the mass of the molded article. The top four molding condition element items are displayed in descending order of the degree of influence. Specifically, the molding condition element item “A” having the highest degree of influence on the mass is displayed in the top row of the display unit 57, along with its degree of influence of 40%. Further, the other three molding condition element items “C”, “E”, and “F” are displayed on the display unit 57 in this order from top down, along with their degrees of influence of 20%, 6%, and 5%, respectively.

When the mass of a molded article has deviation from its target value, the operator inputs the item name “mass” to the input unit 55 as described above. In response to the input, the display unit 57 displays information in a manner illustrated in FIG. 7, thus informing the operator which molding condition element items have influence on the mass. Further, the operator is informed how much the molding condition element items influence the mass. This allows the operator, for example, to determine, on the basis of the degree of influence, which molding condition element items to adjust with the amount of deviation from the target value taken into account. For example, the operator may choose to adjust the molding condition element item having an degree of influence of 20%, instead of the molding condition element item having the highest degree of influence. Usually it is not necessary to adjust all the molding condition element items that have the degree of influence on the quality element of a molded article. In other words, it is sufficient to adjust a predetermined number of the top molding condition element items that have the degree of influence on the quality element. In this third display example, since only a predetermined number of the top molding condition element items are displayed as output information, information on the display unit 57 is easily viewable.

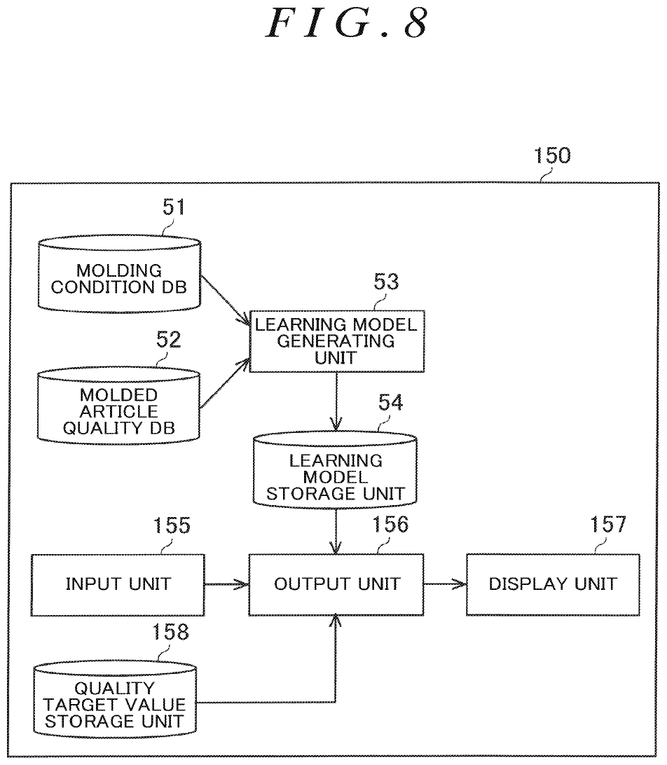

Next, the structure of a molding condition determination assisting device 150 (hereinafter referred to simply as the assisting device 150) according to a second embodiment is described with reference to FIG. 8. The assisting device 150 includes a molding condition database (DB) 51, a molded article quality database (DB) 52, a learning model generating unit 53, a learning model storage unit 54, an input unit 155, an output unit 156, a display unit 157, and a quality target value storage unit 158. The assisting device 150 has some common structural features with the assisting device 50 of the first embodiment. The common structural features are denoted by the same reference symbols, and their description is omitted for the sake of brevity.

The input unit 155 receives input of a subject quality element item to be checked and an output condition (i.e., display order of items, the number of items to be displayed, and information about whether to output the degrees of influence). Further, when the subject quality element item has deviation from its target value, the input unit 155 is capable of receiving input of the amount of deviation from the target value in addition to the subject quality element item. Instead of the amount of deviation, the input unit 155 may receive input of the value itself of the subject quality element item.

The quality target value storage unit 158 stores target values for quality element items for an article to be molded. The target values for the quality element items are used for comparison with values of corresponding quality element items of a molded article input to the input unit 155.

The output unit 156 outputs, using the learning model, molding condition element items that have the degree of influence on the subject quality element item. The output unit 156 has the same function as the output unit 56 of the assisting device 50 described in the first embodiment. Further, the output unit 156 has a feature that recommends, in accordance with the degrees of influence, which molding condition element items to adjust in order to eliminate the deviation of the subject quality element item. In summary, the output unit 156 uses the learning model and recommends, on the basis of the degrees of influence and the amount of deviation, which molding condition element items to adjust in order to eliminate the deviation of the subject quality element item. In addition to the above feature that recommends, in accordance with the degrees of influence, which molding condition element items to adjust, the output unit 156 has another feature that recommends how much to adjust the recommended molding condition element items.

The display unit 157 displays the input information and the output condition input to the input unit 155 and also displays the output information output from the output unit 156. Details of the display unit 157 are described later.

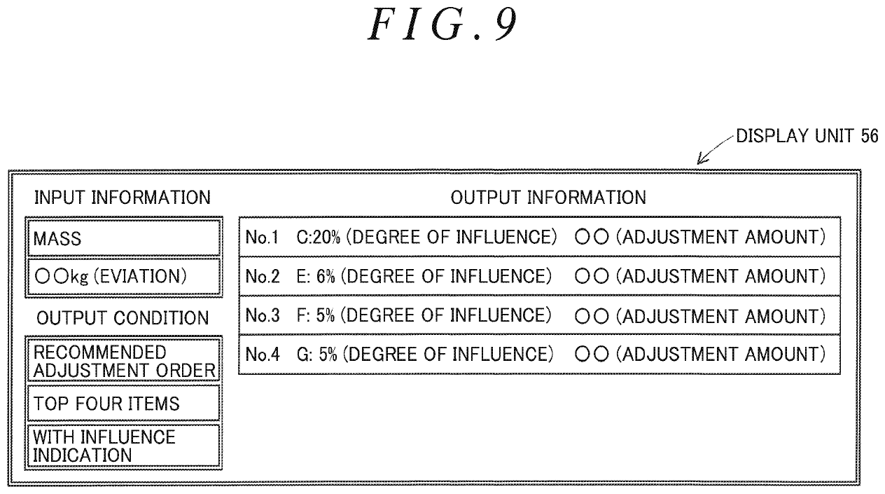

Referring to FIG. 9, a fourth display example of the display unit 157 is described. The first display example illustrates when the input unit 155 receives the following input information: the item name “mass” as the subject quality element item; and the amount of deviation of the value of the subject quality element item from its target value. Further, in this example, the following output condition is input to the input unit 155: recommended order for adjustment; top four items as a predetermined number of items; and with indication of the degree of influence. The input information and the output condition are displayed on the display unit 157 (on the left side of FIG. 9).

Further, output information output from the output unit 156 is also displayed on the display unit 157 (on the right side of FIG. 9). As illustrated in FIG. 9, the display unit 157 displays the top four molding condition element items in the recommended order for adjustment, out of all the molding condition element items that have the degree of influence on the mass of the molded article. Specifically, the molding condition element item “C” that is the most highly recommended item for adjustment to eliminate the deviation of the mass is displayed in the top row of the display unit 157, along with its degree of influence of 20% and its adjustment amount. Further, the other three molding condition element items “E”, “F”, and “G” are displayed on the display unit 157 in the recommended order from top down, along with their respective degrees of influence of 6%, 5%, and 5% and their respective adjustment amounts.

When the mass of a molded article has deviation from its target value, the operator inputs both the item name “mass” and the amount of deviation to the input unit 155 as described above. In response to the input, the display unit 157 displays information in a manner illustrated in FIG. 9, thus informing the operator which molding condition element items have influence on the mass. Further, the operator is informed how much and which molding condition element items to adjust in order to eliminate the deviation for the mass.

The output unit 156 does not always recommend one molding condition element item to adjust in order to eliminate the deviation of the subject quality element item. In some cases, the output unit 156 recommends multiple molding condition element items to adjust. In such cases, the display unit 157 displays a plurality of recommended molding condition element items in the recommended order for adjustment, thereby informing the operator of the plurality of recommended molding condition element items. This allows the operator to adjust the molding condition element items such that the subject quality element item meets the target value.

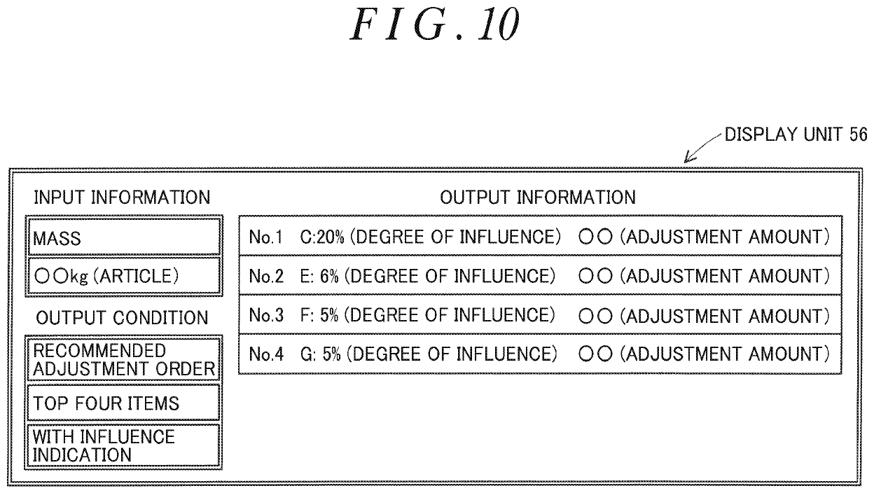

Next, a fifth display example of the display unit 157 is described with reference to FIG. 10. The second display example illustrates when the input unit 155 receives the following input information: the item name “mass” as the subject quality element item; and the value of the subject quality element item (i.e., the mass value of the molded article). Further, in this example, the following output condition is input to the input unit 155: recommended order for adjustment; top four items as a predetermined number of items; and with indication of the degree of influence. The input information and the output condition are displayed on the display unit 157 (on the left side of FIG. 10).

Further, output information output from the output unit 156 is also displayed on the display unit 157 (on the right side of FIG. 10). As illustrated in FIG. 10, the display unit 157 displays the top four molding condition element items in the recommended order for adjustment, out of all the molding condition element items that have the degree of influence on the mass of the molded article. The output unit 156 obtains the amount of deviation by comparing the value of the subject quality element item input to the input unit 155 with a corresponding target value stored in the quality target value storage unit 158. On the basis of the amount of deviation, the output unit 156 determines the recommend order for adjustment.

As a result, the molding condition element item “C” that is the most highly recommended item for adjustment to eliminate the deviation of the mass is displayed in the top row of the display unit 157, along with its degree of influence of 20% and its adjustment amount. Further, the other three molding condition element items “E”, “F”, and “G” are displayed on the display unit 157 in the recommended order from top down, along with their respective degrees of influence of 6%, 5%, and 5% and their respective adjustment amounts.

In summary, according to this example, when a subject quality element item to be checked has deviation from its target value, the operator inputs the value itself of the subject quality element item, without calculating the amount of deviation. In response to the input, the display unit 157 displays information in a manner illustrated in FIG. 10. Thus, the operator is informed how much and which molding condition element items need to be adjusted in order to eliminate the deviation of the subject quality element item.

What is claimed is:

1. A device for assisting molding condition determination and for use with a molding method that molds an article by feeding molten material into a mold, the device comprising:
a learning model generating unit that creates a learning model through machine learning in which a plurality of molding condition element items used to mold the article and a plurality of quality element items of the molded article are used as learning data, the learning model relating to a degree of influence of each of the molding condition element items on each of the quality element items;
an input unit that receives input of a subject quality element item to be checked, the subject quality element item selected from the quality element items; and
an output unit that outputs, using the learning model, the molding condition element item that has the degree of influence on the subject quality element item.

2. The device according to claim 1, wherein the output unit outputs the molding condition element item having the degree of influence on the subject quality element item that is high.

3. The device according to claim 1, wherein the output unit outputs the molding condition element item that has the degree of influence on the subject quality element item, and a value of the degree of influence.

4. The device according to claim 1, wherein the output unit has a predetermined number of the molding condition element items to be output, and outputs the predetermined number of the molding condition element items that have the degree of influence on the subject quality element item, in descending order of the degree of influence on the subject quality element item.

5. The device according to claim 1, wherein:
when the subject quality element item has deviation from a target value for the subject quality element item, the input unit receives input of the subject quality element item and the deviation between the subject quality element item and the target value; and
the output unit recommends, in accordance with the degree of influence on the subject quality element item, which of the molding condition element items to adjust in order to eliminate the deviation.

6. The device according to claim 5, wherein the output unit recommends, in accordance with the degree of influence, how much and which of the molding condition element items to adjust.

7. The device according to claim 1, wherein the learning model is a graphical model.

8. An injection molding apparatus comprising the device according to claim 1.
